(19) United States
(12) Patent Application Publication
(10) Pub. No.: US 2020/0372315 A1
(43) Pub. Date: Nov. 26, 2020

(54) SYSTEM AND METHOD FOR CARRYING OUT A VEHICLE ACTION BASED ON A SENSOR TAG STATE

(71) Applicant: GM GLOBAL TECHNOLOGY OPERATIONS LLC, Detroit, MI (US)

(72) Inventors: Robert C. Jablonski, Rochester Hills, MI (US); Ki Hyun Ahn, Troy, MI (US); Joseph F. Szczerba, Grand Blanc, MI (US)

(21) Appl. No.: 16/419,602

(22) Filed: May 22, 2019

(51) Int. Cl. G06K 19/07; G07C 9/00; G01S 11/04

(52) U.S. Cl. CPC G06K 19/0723; G07C 2209/63; G01S 11/04; G07C 9/00309

(57) ABSTRACT

A system and method for carrying out a vehicle action based on a state of a sensor tag that is attachable to an asset or a personal item. The method includes: configuring the sensor tag to be associated with the asset, wherein the configuring step includes receiving asset attribute information concerning the asset; obtaining sensor tag state information regarding a state of the sensor tag, wherein the sensor tag state information includes information received from the sensor tag and/or information concerning the presence or absence of the sensor tag at the vehicle; detecting a vehicle trigger event, wherein the vehicle trigger event is an occurrence of a vehicle trigger, and the vehicle trigger specifies one or more conditions pertaining to the state of the sensor tag; and carrying out a vehicle action at the vehicle in response to the detection of the vehicle trigger event.

### INTRODUCTION

The present disclosure relates to carrying out a vehicle action based on a state of a sensor tag that is attachable to an asset.

Vehicles include electronic control units (ECUs) that carry out various tasks for the vehicle. Many vehicles now include various sensors to sense information concerning the vehicle's operation and the vehicle environment, and also include means for obtaining information from other electronic devices that may be present at the vehicle, such as smartphones and other smart devices. However, a user may use a vehicle to transport or carry personal items or assets (e.g., a bicycle, a briefcase, etc.) that do not include any electronics or components that enable the device to be detectable by the vehicle system or to communicate with the vehicle system. The present disclosure is designed to address such situations.

### SUMMARY

According to one aspect, there is provided a method of carrying out a vehicle action based on a state of a sensor tag that is attachable to an asset. The method includes: configuring the sensor tag to be associated with the asset, wherein the configuring step includes receiving asset attribute information concerning the asset; obtaining sensor tag state information regarding a state of the sensor tag, wherein the sensor tag state information includes information received from the sensor tag and/or information concerning the presence or absence of the sensor tag at the vehicle; detecting a vehicle trigger event, wherein the vehicle trigger event is an occurrence of a vehicle trigger, and the vehicle trigger specifies one or more conditions pertaining to the state of the sensor tag; and carrying out a vehicle action at the vehicle in response to the detection of the vehicle trigger event, wherein the vehicle action is part of a vehicle trigger-action and is designed to address the one or more conditions of the vehicle trigger event.

According to various embodiments, the method may further include any one of the following features or any technically-feasible combination of some or all of these features:
the configuring step includes receiving the asset attribute information at the vehicle, and storing the asset attribute information at the vehicle;
the asset attribute information is received via a vehicle-user interface, and the asset attribute information is manually input into a graphical user interface by a user through the vehicle-user interface;
the asset attribute information is received from one or more servers at a remote facility or from a handheld wireless device (HWD);
the sensor tag includes a radio frequency identifier (RFID) component, the vehicle includes one or more RFID readers, and the sensor tag state information is obtained by detecting the presence or absence of the sensor tag at the vehicle via the one or more RFID readers detecting the RFID component;
the sensor tag includes a short-range wireless communication (SRWC) circuit, the sensor tag state information is obtained by receiving a wireless SRWC signal at the vehicle from the sensor tag via a SRWC connection between the sensor tag and the vehicle;
the position of the sensor tag is determined relative to the vehicle or a reference component of the vehicle based on an angle of arrival (AoA) and/or an angle of departure (AoD) of the wireless signal;
the sensor tag includes an inertial sensor, and the sensor tag state information includes information based on a measurement of the inertial sensor;
the configuring step includes obtaining orientation information concerning an orientation of the sensor tag relative to the asset so that an orientation of the asset relative to earth or gravity can be determined based on the measurement of the inertial sensor.
the vehicle trigger is a user-defined vehicle trigger that is specified by input received from a user input via one or more human-machine interfaces;
the vehicle trigger is an automatically generated vehicle trigger that is generated based on the asset attribute information, and the vehicle trigger is automatically generated at a remote facility or is automatically generated at the vehicle based on information received from the remote facility;
the vehicle trigger is automatically generated through a vehicle trigger-action learning process, wherein the vehicle trigger-action learning process includes processing previously observed vehicle state information and previously observed sensor tag state information using an artificial intelligence (AI) technique; and/or
the sensor tag includes a housing, and wherein an adhesive is applied to at least one surface of the housing of the sensor tag so as to enable the sensor tag to be adhered to the asset.

According to another aspect, there is provided a vehicle communication system. The vehicle communication system includes: at least one sensor tag that is attachable to an asset and that includes sensor tag electronics, the sensor tag electronics include a radio frequency identifier (RFID) component and/or a short-range wireless communication (SRWC) circuit; vehicle electronics for installation in a vehicle, the vehicle electronics include: (a) one or more RFID readers and/or one or more SRWC circuits; (b) an onboard computer having a processor; (c) a memory storing computer instructions, the memory is accessible by the processor of the onboard computer; wherein, when the processor of the onboard computer executes the computer instructions, the vehicle electronics: (a) obtain sensor tag state information regarding a state of the sensor tag, wherein the sensor tag state information includes information received from the sensor tag and/or information concerning the presence or absence of the sensor tag at the vehicle; (b) detect a vehicle trigger event, wherein the vehicle trigger event is based on an occurrence of a vehicle trigger, and the vehicle trigger specifies one or more conditions pertaining to the state of the sensor tag; and (c) carry out a vehicle action at the vehicle in response to the detection of the vehicle trigger event, wherein the vehicle action is part of a vehicle trigger-action and is designed to address the one or more conditions of the vehicle trigger event.

According to various embodiments, the vehicle communication system may further include any one of the following features or any technically-feasible combination of some or all of these features:
the at least one sensor tag includes the RFID component and lacks the SRWC circuit or any SRWC circuit, and wherein the vehicle electronics includes a plurality of RFID readers positioned around the vehicle so as to have separate RFID read zones;
the at least one sensor tag each includes attachment mechanism for being attached to the asset;
the attachment mechanism includes an adhesive disposed on an outer surface of a housing of the sensor tag;
the at least one sensor tag includes a plurality of sensor tags, and wherein the one or more conditions of the vehicle trigger pertain to at least two of the plurality of sensor tags; and/or
the sensor tag includes at least one sensor, wherein the sensor tag includes the SRWC circuit, and wherein the sensor tag is configured to send the sensor tag state information to the vehicle via the SRWC circuit.

According to another aspect, there is provided a method of carrying out a vehicle action based on a state of a sensor tag that is attachable to an asset. The method includes: associating a sensor tag with a vehicle, wherein the associating step includes storing a sensor tag identifier and a vehicle identifier in a manner such that the sensor tag identifier is linked or associated with the vehicle identifier; receiving asset attribute information at the vehicle, wherein the asset attribute information is information concerning an asset to which the sensor tag is attached or is to be attached; configuring the vehicle to monitor for a vehicle trigger event, wherein the vehicle trigger event is based on an occurrence of a vehicle trigger, the vehicle trigger specifies one or more conditions pertaining to the state of the sensor tag, and the configuring step includes storing information representing the one or more conditions of the vehicle trigger into memory of the vehicle; obtaining sensor tag state information regarding a state of the sensor tag, wherein the sensor tag state information includes information received from the sensor tag and/or information concerning the presence or absence of the sensor tag at the vehicle; monitoring for a vehicle trigger event based on the obtained sensor tag state information and the stored information representing the one or more conditions of the vehicle trigger; detecting the vehicle trigger event at the vehicle; and carrying out a vehicle action at the vehicle in response to the detection of the vehicle trigger event, wherein the vehicle action is part of a vehicle trigger-action and is designed to address the one or more conditions of the vehicle trigger event.

### BRIEF DESCRIPTION OF THE DRAWINGS

One or more embodiments of the disclosure will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is an illustration depicting a first or front surface of a sensor tag along with a block diagram of sensor tag electronics according to one embodiment;

FIG. 3 is an illustration depicting a second or back surface of the sensor tag of FIG. 2 having an adhesive thereon according to one embodiment;

FIG. 4 is an illustration depicting an exemplary scenario in which a first sensor tag is attached to a first asset (a bicycle) and a second sensor tag is attached to a second asset (a helmet);

FIG. 5 is a flowchart depicting an embodiment of a sensor tag configuration process that can be used as a part of a method of carrying out a vehicle action based on a state of a sensor tag that is attachable to an asset;

FIG. 6 is a flowchart depicting an embodiment of a vehicle trigger event detection process that can be used as a part of a method of carrying out a vehicle action based on a state of a sensor tag that is attachable to an asset; and

FIG. 7 is an illustration depicting an exemplary scenario in which the first asset (the bicycle) having the first sensor tag is mounted to a roof rack of the vehicle.

### DETAILED DESCRIPTION OF THE ILLUSTRATED EMBODIMENT(S)

The system and method below enable a vehicle action to be carried out based on a state of a sensor tag. As mentioned above, many vehicles are capable of interacting with numerous electronic devices, including smart devices. However, many personal items or assets of a user may lack the capabilities to communicate information to a vehicle, and/or may not be readily detectable by the vehicle. Thus, a sensor tag that includes sensor tag electronics is provided, and these sensor tag electronics enable a state of the sensor tag to be determined by the vehicle and then used to select one or more vehicle actions to be carried out. That is, the vehicle can carry out the one or more vehicle actions based on the state of the sensor tag (referred to herein as the “sensor tag state”). According to many embodiments, the sensor tag electronics include either or both of a short-range wireless communication (SRWC) component (e.g., SRWC circuit and antenna) and a radio frequency identifier (RFID) component (e.g., RFID circuit and antenna).

In one embodiment where the sensor tag includes the SRWC circuit, the sensor tag can transmit wireless message(s) to the vehicle, such as to a wireless communications device of the vehicle. The wireless message(s) can be used to transfer information between the sensor tag and the vehicle, such as for sending sensor tag state information (as initially obtained by the sensor tag electronics) to the vehicle. In one embodiment, the wireless message(s) can be used to determine the position of the sensor tag (and, thus, the position of the asset to which it is attached) relative to the vehicle (or a reference component of the vehicle, such as the wireless communications device). Also, in one embodiment where the sensor tag includes the SRWC circuit, the sensor tag can include an inertial sensor (or other sensor (e.g., a digital thermometer)) that can obtain sensor tag sensor data. According to one embodiment, the sensor tag sensor data includes information representing an orientation of the sensor tag, such as an orientation of the sensor tag relative to earth or gravity.

In some embodiments where the sensor tag includes the RFID component, the vehicle can include one or more RFID readers that are positioned around the vehicle at various locations, such as on the front of the vehicle, on the rear of the vehicle, on the roof of the vehicle, in a glovebox of the vehicle, etc. For example, a first RFID reader can be positioned near the trunk of the vehicle, a second RFID reader can be positioned in the glovebox of the vehicle, and a third RFID reader can be positioned in or near a roof rack of the vehicle. These RFID readers can thus be used to determine the presence or absence of a sensor tag within the RFID read zone of those RFID readers. This information indicating the presence or absence of the sensor tag is considered sensor tag state information and can be used by the vehicle in detecting a vehicle trigger event. Once the vehicle trigger event is detected, the vehicle carries out a vehicle action associated with the vehicle trigger. The vehicle action can include, for example, providing a notification to a vehicle user or operating an electromechanical device of the vehicle, such as lowering the suspension height of the vehicle.

In one exemplary scenario, a first sensor tag can be attached to a bicycle (a first asset). A sensor tag configuration process can be carried out in which asset attribute information pertaining to the first asset can be obtained at the vehicle, such as from a user inputting information into a graphical user interface (GUI) of the vehicle. The asset attribute information can indicate, for example, the type of asset, the height of the asset, the width of the asset, the residence of the asset, etc. This information can then be used by the vehicle in determining to carry out one or more vehicle actions. For example, when the vehicle detects that the bicycle is mounted to a roof rack of the vehicle (e.g., through an RFID reader of the vehicle being positioned on the roof), the vehicle can then carry out a vehicle action so as to prevent the user from driving the vehicle in an area where the clearance height is less than the height of the vehicle plus the height of the bicycle that is mounted on the roof. According to one embodiment, in such a scenario, the vehicle action can be providing a notification (e.g., a warning) to the driver or other user of the vehicle that indicates the clearance ahead is too low. Or, according to another embodiment, in such a scenario, the vehicle action can be applying the vehicle brakes (an example of an electromechanical device) so as to prevent the vehicle from proceeding to the area in which the clearance is too low. Various other scenarios and embodiments exist, as will be appreciated by those skilled in the art in light of the discussion below.

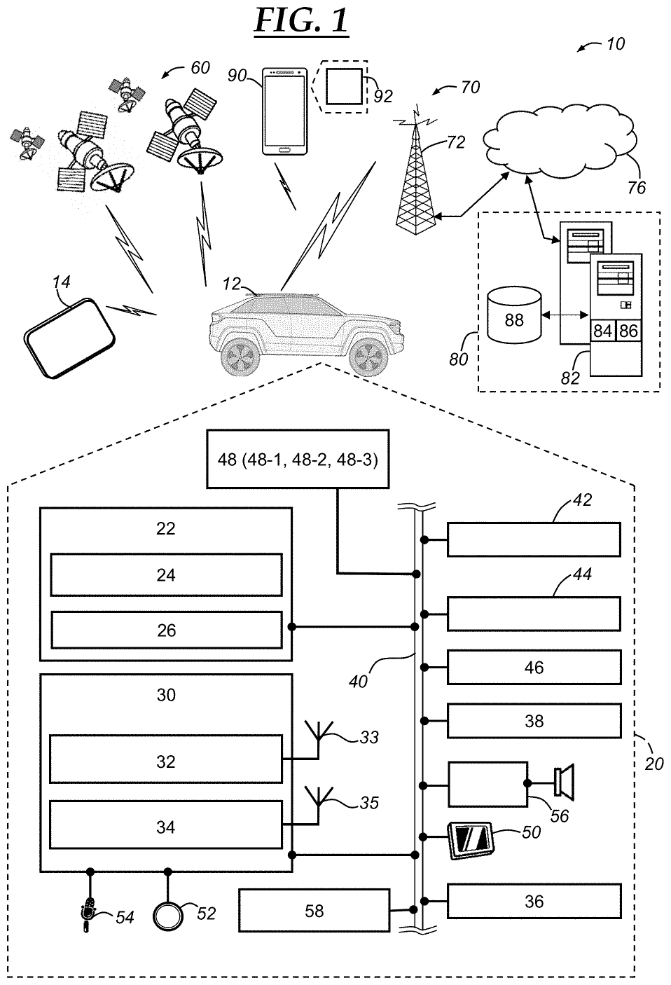

FIG. 1 illustrates an operating environment that comprises a communications system 10 and that can be used to implement the method disclosed herein. The communications system 10 generally includes a vehicle 12 with vehicle electronics 20, at least one sensor tag 14, a plurality of global navigation satellite system (GNSS) satellites 60, a wireless carrier system 70, a land network 76, and a remote facility 80. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a sports utility vehicle (SUV), but it should be appreciated that any other vehicle including motorcycles, trucks, passenger cars, recreational vehicles (RVs), all-terrain vehicles (ATVs), marine vessels, aircraft, etc., can also be used. Portions of the vehicle electronics 20 are shown generally in FIG. 1 and include an onboard computer 22, wireless communications device 30, a GNSS receiver 36, a body control module (BCM) 38, a communications bus 40, onboard vehicle sensors 42-46, vehicle-user interfaces 50-56, and suspension height electromechanical device 58. Some or all of the different vehicle electronics may be connected for communication with each other via one or more communication busses, such as communications bus 40. The communications bus 40 provides the vehicle electronics 20 with network connections using one or more network protocols, and can use a serial data communication architecture. Examples of suitable network connections include a controller area network (CAN), a media oriented system transfer (MOST), a local interconnection network (LIN), a local area network (LAN), and other appropriate connections, such as Ethernet or others that conform with known ISO, SAE, and IEEE standards and specifications, to name but a few.

Skilled artisans will appreciate that the schematic block diagram of the vehicle electronics 20 is simply meant to illustrate some of the more relevant hardware components used with the present method and it is not meant to be an exact or exhaustive representation of the vehicle hardware that would typically be found on such a vehicle. Furthermore, the structure or architecture of the vehicle electronics 20 may vary substantially from that illustrated in FIG. 1. Thus, because of the countless number of potential arrangements and for the sake of brevity and clarity, the vehicle electronics 20 is described in conjunction with the illustrated embodiment of FIG. 1, but it should be appreciated that the present system and method are not limited to such.

Onboard computer 22 is part of the vehicle electronics 20 and includes a processor 24 and memory 26. In one embodiment, the onboard computer 22 can be configured to perform one or more steps of the method(s) discussed below. Also, in embodiments where the onboard computer 22 carries out one or more method steps, the onboard computer 22 can do so using the processor 24. According to various embodiments, the onboard computer 22 can be integrated into other devices or components of the vehicle electronics 20. Additionally, at least in some embodiments, the onboard computer 22 can be (or can be integrated with) an infotainment unit (e.g., an infotainment head unit, an in-car entertainment (ICE) unit, in-vehicle infotainment (IVI)), a vehicle head unit, a center stack module (CSM), or vehicle navigation module.

Wireless communications device 30 provides the vehicle with wireless communication capabilities, including short-range wireless communication (SRWC) capabilities using the SRWC circuit 32 and long-range wireless communication (LRWC) capabilities using a LRWC circuit, such as the cellular chipset 34. Although the LRWC circuit is described herein as the cellular chipset 34, those skilled in the art will appreciate that other LRWC hardware and/or circuitry can be used. The SRWC circuit 32 enables the vehicle to communicate with one or more local devices (e.g., the sensor tag 14, handheld wireless device (HWD) 90) via SRWC techniques, which can include Wi-Fi™, WiMAX™, Wi-Fi Direct™, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, Bluetooth™ 5.1, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The SRWC circuit 32 can transmit and receive communications via antenna 33 and, although a single antenna 33 for the SRWC circuit 32 is depicted in FIG. 1, it should be appreciated that a plurality of antennas can be used for communications between the SRWC circuit 32 and another SRWC device. An SRWC device is a device that is capable of carrying out communications using one or more SRWC techniques, such as those listed above. In at least some embodiments, the SRWC circuit 32 can enable the vehicle to carry out vehicle-to-vehicle (V2V) communications and vehicle-to-infrastructure (V2I) communications.

The cellular chipset 34 can be a cellular chipset that enables cellular wireless communications, such as those used with wireless carrier system 70. The antenna 35 of the wireless communications device 30 can be used to transmit and receive these wireless communications and, although a single antenna 35 for the cellular chipset 34 is depicted in FIG. 1, it should be appreciated that a plurality of antennas can be used by the cellular chipset 34. Although the illustrated embodiment depicts the SRWC circuit 32 and the cellular chipset 34 as being a part of a single module (the wireless communication device 30), in other embodiments, the SRWC circuit and the cellular chipset can be a part of different modules—for example, the SRWC circuit can be a part of the onboard computer 22, and the cellular chipset 32 can be a part of a telematics unit that is separate from the onboard computer 22. Also, at least in some embodiments, the wireless communications device 30 can include a processor and memory.

Global navigation satellite system (GNSS) receiver 36 receives radio signals (referred to as GNSS signals) from the plurality of GNSS satellites 60. The GNSS receiver 36 can be configured to comply with and/or operate according to particular regulations or laws of a given geopolitical region (e.g., country). The GNSS receiver 36 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. The GNSS receiver 36 can include at least one processor and memory, including a non-transitory computer readable memory storing instructions (software) that are accessible by the processor for carrying out the processing performed by the GNSS receiver 36. The GNSS receiver 36 may be used as a part of providing navigation and other position-related services to the vehicle operator. The navigation services can be provided using a dedicated in-vehicle navigation module (which the GNSS receiver 36 can be a part of and/or incorporated as a part of another module that performs such services, such as the wireless communications device 30), or some or all navigation services can be done via the wireless communications device 30 (or other telematics-enabled device) installed in the vehicle, wherein the position information is sent to a remote location for purposes of providing the vehicle with navigation maps, map annotations (points of interest, restaurants, etc.), route calculations, and the like.

The GNSS receiver 36 can thus determine a geographical location of the vehicle 12 based on information contained in a plurality of GNSS signals received from the plurality of GNSS satellites 60. The geographical location can include or be represented by a geographical coordinate, which can be a longitudinal/latitudinal coordinate pair, for example. Also, in at least some embodiment, the geographical location can include an elevation. In some embodiments, the GNSS receiver 36 (or other portion of the vehicle electronics 20) can determine a vehicle trajectory or other position-related information pertaining to the vehicle 12, which can include a vehicle location, a vehicle heading, a vehicle speed (or velocity), a vehicle acceleration, etc. This data obtained or derived from the GNSS receiver 36 (i.e., the “GNSS data”) can be sent to other portions of the vehicle electronics 20, including the wireless communications device 30 and/or the onboard computer 22. The GNSS data may also be sent from the wireless communications device 30 to the remote facility 80 via the wireless carrier system 70 and/or the land network 76.

Body control module (BCM) 38 can be used to control various components of the vehicle, as well as obtain information concerning various components of the vehicle, including their present state or status. The BCM 38 is shown in the exemplary embodiment of FIG. 1 as being electrically coupled to communication bus 40. In some embodiments, the BCM 38 may be integrated with or part of a center stack module (CSM) and/or integrated with wireless communications device 30. Or, the BCM 38 may be a separate device that is connected to other vehicle electronics via the communications bus 40. The BCM 38 can include a processor and/or memory. The BCM 38 may communicate with the onboard computer 22, the wireless communications device 30, the onboard vehicle sensors 42-46, and/or one or more other devices or modules of the vehicle electronics 20. The BCM 38 can direct one or more vehicle actions including, for example, controlling central locking, air conditioning (or other HVAC functions), power mirrors, and/or controlling various other vehicle modules. For example, the BCM 38 can send signals to other modules and devices of the vehicle electronics 20, such as by sending vehicle sensor data to the onboard computer 22.

The BCM 38 may determine or obtain vehicle state information, which is information corresponding to the vehicle state including vehicle operating state information and vehicle environment state information. The vehicle operating state information is information representing or indicating the state of the vehicle electronics 20 (including any one or more of the devices therein), or other vehicle components or subsystems. The vehicle environment state information is information concerning the environment of the vehicle, such as the presence of non-vehicle electronics or devices (e.g., HWD 90, the sensor tag 14), conditions of the environment that are observable by the vehicle (through the user of onboard vehicles sensor, for example), and conditions of the environment that are obtained by the vehicle (e.g., traffic information concerning nearby traffic that is received from a remote server). As an example of vehicle operating state information, the BCM 38 may provide the onboard computer 22 with information indicating whether the vehicle's primary propulsion system is engaged or in an active (or ready) state (or when the ignition is turned on as received from an engine control module in an ICE vehicle). As another example, the BCM 38 can send the onboard computer 22 a status indicator that indicates whether a door of the vehicle is open, closed, unlocked, and/or locked.

The vehicle state information can include GNSS data, vehicle sensor data, and/or various other data that is communicated over the communications bus 40 or obtained at the vehicle electronics 20. The vehicle state information can be sent to the onboard computer 22 (or other vehicle computer or device (e.g., wireless communication device 30)) in response to receiving a request from the device/computer, upon certain conditions being met, or periodically (e.g., at set time intervals). In one embodiment, the vehicle state information can be sent to the remote facility 80 using the wireless communications device 30, for example. This vehicle state information can then be stored in one or more databases 88 of the remote facility 80. In at least some embodiments, the BCM 38 can used the vehicle state information to monitor for a vehicle trigger event, which is discussed more below. In some embodiments, when a vehicle trigger event is detected, vehicle state information or other information derived therefrom can be sent from the BCM 38 to the onboard computer 22 (or other portions of the vehicle electronics 20 (e.g., wireless communications device 30)), which can then process the vehicle state information (or other data derived therefrom) and/or send this information to the remote facility 80 or to the sensor tag 14. In other embodiments, other modules of the vehicle electronics 20 can detect the vehicle trigger event, and/or provide vehicle state information to the onboard computer 22 (or other portions of the vehicle electronics 20 (e.g., wireless communications device 30)) in response thereto.

Onboard vehicle sensors 42-46 can capture or sense information pertaining to the vehicle, which can then be sent to one or more other parts of the vehicle electronics 20 and/or external systems or devices, such as the remote facility 80. The vehicle sensor data obtained by the onboard vehicle sensors 42-46 can be associated with a time indicator (e.g., a timestamp), as well as other metadata or information. The vehicle sensor data can be obtained by the onboard vehicle sensors 42-46 in a raw format, and/or may be processed by the sensors, such as for purposes of compression, filtering, and/or other formatting, for example. Moreover, the vehicle sensor data (in its raw or formatted form) can be sent to one or more other portions of the vehicle electronics 20 via communications bus 40, such as to the wireless communications device 30, the onboard computer 22, and/or the body control module (BCM) 38. In at least one embodiment, the wireless communications device 30 can package the vehicle sensor data for transmission and send the vehicle sensor data to other systems or devices, such as a remote computer 82 at the remote facility 80.

Suspension sensors 42 are used to provide suspension sensor data, which is a type of vehicle sensor data. The suspension sensor data can be used to determine a suspension distance, which is a distance between an associated vehicle wheel (or the ground) and a reference point of the vehicle body. In one embodiment, the suspension sensors 42 can include a strain gauge that can generate suspension sensor data used to determine a suspension distance. Those skilled in the art will appreciate that various suspension sensors can be used to provide the suspension sensor data, which can then be used to determine a suspension distance. In one example, the suspension distance represents a distance between a reference point on the vehicle wheel and a reference point on the vehicle body, and/or may represent the change (or difference) between a resting suspension distance and a measured suspension distance. In one embodiment, the vehicle includes four wheels and four suspension sensors 42, each of which is associated with one of the vehicle wheels. Of course, in other embodiments, the vehicle can include a different number of wheels and/or suspension sensors.

In one embodiment, the suspension sensors 42 can be used to provide feedback information to the BCM 38, onboard computer 22, and/or a suspension height electromechanical device 58, which is an electromechanical device that is controllable by the vehicle electronics and that is used to adjust the suspension height of the vehicle 12. In some embodiments, the onboard computer 22 and/or the BCM 38 can control the suspension height of the vehicle through sending control signals to the suspension height electromechanical device 58. This adjustment of the height through the suspension height electromechanical device 58 is considered a vehicle action, and can be carried out as a part of the method discussed below.

The movement sensor(s) 44 include one or more onboard vehicle sensors that can be used in some implementations to obtain movement and/or inertial information concerning the vehicle 12, such as vehicle speed, acceleration, yaw (and yaw rate), pitch, roll, and various other attributes of the vehicle concerning its movement as measured locally through use of onboard vehicle sensors. Although only a single movement sensor 44 is shown and described, it should be appreciated that the vehicle 12 can include any number of movement sensors. The movement sensors 44 can be mounted on the vehicle 12 in a variety of locations, such as within an interior vehicle cabin, on a front or back bumper of the vehicle, and/or on the hood of the vehicle 12. The movement sensors 44 can be coupled to various other VSMs directly or via communications bus 40. Movement sensor data can be obtained and sent to the other VSMs, including BCM 38, onboard computer 22, and/or wireless communications device 30.

In some embodiments, the movement sensor(s) 44 can include inertial sensor(s), which can be installed on the vehicle as onboard vehicle sensors. The inertial sensor(s) can be used to obtain vehicle inertial sensor data, which is a type of vehicle sensor data that may be used to determine the acceleration and the direction of the acceleration of the vehicle or a part thereof. The vehicle inertial sensor data is a type of movement sensor data and also a type of vehicle sensor data. The inertial sensor(s) can each be microelectromechanical systems (MEMS) sensor or accelerometer, and may be part of an inertia measurement unit (IMU). In one embodiment, the inertial sensor can be used to detect collisions based on a detection of a relatively high deceleration. In one embodiment, vehicle inertial sensor data can be continuously gathered and sent to the onboard computer 22 (or other portions of the vehicle electronics 20), which may then process the vehicle inertial sensor data for various purposes. In some embodiments, any one or more of the inertial sensor(s) can be a multi-axis accelerometer that can measure acceleration or inertial force along a plurality of axes. The plurality of axes may each be orthogonal or perpendicular to one another and, additionally, one of the axes may run in the direction from the front to the back of the vehicle 12. Other embodiments may employ single-axis accelerometers or a combination of single- and multi-axis accelerometers. Other types of sensors can be used, including other accelerometers, gyroscope sensors, and/or other inertial sensors that are known or that may become known in the art.

Alternatively or additionally, the movement sensors 44 can include wheel speed sensors, which can be installed on the vehicle as onboard vehicle sensors. The wheel speed sensors are each coupled to a wheel of the vehicle 12 and can determine a rotational speed of the respective wheel. The rotational speeds from various wheel speed sensors can then be used to obtain a linear or transverse vehicle speed. Additionally, in some embodiments, the wheel speed sensors can be used to determine acceleration of the vehicle. In some embodiments, wheel speed sensors can be referred to as vehicle speed sensors (VSS) and can be a part of an anti-lock braking (ABS) system of the vehicle 12 and/or an electronic stability control program.

Alternatively or additionally, the movement sensors 44 can include one or more yaw rate sensors, which can be installed on the vehicle as an onboard vehicle sensor. The yaw rate sensor(s) can obtain vehicle angular velocity information with respect to a vertical axis of the vehicle. The yaw rate sensors can include gyroscopic mechanisms that can determine the yaw rate and/or the slip angle. Various types of yaw rate sensors can be used, including micromechanical yaw rate sensors and piezoelectric yaw rate sensors.

Alternatively or additionally, the movement sensors 44 can include a steering wheel angle sensor, which can be installed on the vehicle as an onboard vehicle sensor. The steering wheel angle sensor is coupled to a steering wheel of vehicle 12 or a component of the steering wheel, which can be a part of the steering column. The steering wheel angle sensor can detect the angle that a steering wheel is rotated, which can correspond to the angle of one or more vehicle wheels with respect to a longitudinal axis of vehicle 12 that runs from the back to the front of the vehicle.

Vehicle camera(s) 46 can include any number of cameras and that may be located around the vehicle at different locations and are configured to provide the vehicle 12 with image data. Each of the vehicle cameras 46 can be used to capture images, videos, and/or other information pertaining to light—this information is referred to herein as “image data”—and can be any suitable camera type. Each of the vehicle cameras 46 may be a charge coupled device (CCD), a complementary metal oxide semiconductor (CMOS) device and/or some other type of camera device, and may have a suitable lens for its location and purpose. According to one non-limiting example, each of the vehicle cameras 46 is a CMOS camera with a fish-eye lens that captures an image having a wide field-of-view (FOV) (e.g., 150°-210°) and provides depth and/or range information for certain objects within the image. Each of the cameras 46 may include a processor and/or memory in the camera itself, or have such hardware be part of a larger module or unit. Some examples of potential features that may be used with one or more of the vehicle cameras 46 include: infrared LEDs for night vision; wide angle or fish eye lenses; stereoscopic cameras with or without multiple camera elements; surface mount, flush mount, or side mount cameras; single or multiple cameras; cameras integrated into tail lights, brake lights, license plate areas, side view mirrors, front grilles, or other components around the vehicle; and wired or wireless cameras, to cite a few possibilities.

The vehicle can include one or more radio frequency identification (RFID) reader(s) 48, each of which can be used to read RFID tag(s) or RFID component(s). As will be discussed more below, the sensor tag 14 can include an RFID circuit and antenna (collectively, an “RFID component”) that includes certain information that is readable or detectable by the RFID readers 48 of the vehicle 12. In the illustrate embodiment, the vehicle 12 includes three RFID readers 48-1, 48-2, and 48-3, each of which can be positioned at various areas on or in the vehicle. For example, a first RFID reader 48-1 can be positioned at the front bumper of the vehicle 12, a second RFID reader 48-2 can be positioned at the rear bumper of the vehicle 12, and a third RFID reader 48-3 can be positioned on the roof rack of the vehicle 12. By positioning these RFID readers around the vehicles at various portions, the vehicle electronics 20 can include numerous RFID read zones that are near portions where an asset having a sensor tag 14 may be provided.

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. Vehicle-user interfaces 50-56 are also onboard vehicle sensors that can receive input from a user or other sensory information. The pushbutton(s) 52 is an input HMI and allows manual user input into the communications device 30 to provide other data, response, or control input. Audio system 56 is an output HMI and provides audio output to a vehicle occupant and can be a dedicated, stand-alone system or part of the primary vehicle audio system. According to the particular embodiment shown here, audio system 56 is operatively coupled to both communication bus 40 and an entertainment bus (not shown) and can provide AM, FM and satellite radio, CD, DVD and other multimedia functionality. This functionality can be provided in conjunction with or independent of an infotainment module. Microphone 54 is an input HMI and provides audio input to the wireless communications device 30 to enable the driver or other occupant to provide voice commands and/or carry out hands-free calling via the wireless carrier system 70. For this purpose, it can be connected to an on-board automated voice processing unit utilizing human machine interface (HMI) technology known in the art. Visual display or touch screen 50 is an output HMI and/or an input HMI (e.g., when the visual display is a touch screen), and can be a graphics display that provides a multitude of input and output functions. The visual display 50 can be a touch screen on the instrument panel, a heads-up display reflected off of the windshield, or a projector that can project graphics for viewing by a vehicle occupant.

Wireless carrier system 70 may be any suitable cellular telephone system. Wireless carrier system 70 is shown as including a cellular tower 72; however, the wireless carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UE) (e.g., wireless communications device 30 in vehicle 12). The wireless carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

Remote facility 80 is a facility that is located remotely from the vehicle 12 and includes one or more electronic computing devices, such as remote computer 82. In the illustrated embodiment, the remote facility 80 includes at least one remote computer 82, which includes a processor 84 and memory 86. The remote facility 80 can be used for one or more purposes, such as for providing backend vehicle services for one or more vehicles, as well as any other cloud-based services. In one embodiment, the remote facility 80 includes a network of remote servers 82 hosted on the internet in a cloud configuration to carry out all or part of the method discussed herein. For example, the processor 84 can execute computer instructions stored on memory 86, which can cause the remote facility 80 to carry out at least a part of the method discussed herein.

The handheld wireless device (HWD) 90 is capable of SRWC, LRWC, or both, and may include: hardware, software, and/or firmware enabling cellular telecommunications and SRWC as well as other mobile device applications, such as a sensor tag configuration application 92. The hardware of the HWD 90 may comprise: a processor and memory for storing the software, firmware, etc. The HWD processor and memory may enable various software applications, which may be preinstalled or installed by the user (or manufacturer) (e.g., having a software application or graphical user interface (GUI)). One implementation of the application 92 enables a vehicle user to communicate with the sensor tag 14, the vehicle 12, the remote facility 80, and/or other devices for purposes of configuring and/or interaction with the sensor tag 14, which is discussed more below. The sensor tag configuration application 92 can be a part of a vehicle management application that enables a user to control various aspects of the vehicle, or may be a separate application.

The processor of the HWD 90 can execute various types of digitally-stored instructions, such as software or firmware programs stored in memory of the HWD 90, which enable the device 90 to provide a wide variety of functionality. For instance, in one embodiment, the processor can execute programs (e.g., the sensor tag configuration application 92) or process data to carry out at least a part of a method discussed herein. In some embodiments, the HWD 90 can be a smartphone or tablet that includes an operating system, such as Android™, iOS™, Microsoft Windows™, and/or other operating systems. The memory of the HWD 90 may include any suitable non-transitory, computer-readable medium or other suitable memory that is installed as a part of the HWD 90. In other embodiments, the memory of HWD 90 may be a non-volatile memory card, such as a Secure Digital™ (SD) card, that is inserted into a card slot of HWD 90.

The HWD 90 can also include a short range wireless communications (SRWC) circuit and/or chipset as well as one or more antennas, which allows it to carry out SRWC, which can include Wi-Fi™, WiMAX™, Wi-Fi Direct™, other IEEE 802.11 protocols, ZigBee™, Bluetooth™, Bluetooth™ Low Energy (BLE), or near field communication (NFC). The SRWC circuit and/or chipset may allow the HWD 90 to connect to another SRWC device, such as the wireless communications device 30 and/or the sensor tag 14. Additionally, the HWD 90 can include a cellular chipset thereby allowing the device to communicate via one or more cellular protocols, such as GSM/GPRS technology, CDMA or CDMA2000 technology, and LTE technology. The HWD 90 may communicate data over wireless carrier system 70 using the cellular chipset and an antenna.

Any one or more of the processors discussed herein (e.g., processor 24, processor of the BCM 38, processor of the wireless communications device 30, processor of the HWD 90) can be any type of device capable of processing electronic instructions including microprocessors, microcontrollers, host processors, controllers, vehicle communication processors, General Processing Unit (GPU), accelerators, Field Programmable Gated Arrays (FPGA), and Application Specific Integrated Circuits (ASICs), to cite a few possibilities. The processor can execute various types of electronic instructions, such as software and/or firmware programs stored in memory, which enable the module to carry out various functionality. Any one or more of the memory discussed herein (e.g., memory 26, memory of the BCM 38, memory of the wireless communications device 30) can be a non-transitory computer-readable medium or other suitable memory; these include different types of random-access memory (RAM) (including various types of dynamic RAM (DRAM) and static RAM (SRAM)), read-only memory (ROM), solid-state drives (SSDs) (including other solid-state storage such as solid state hybrid drives (SSHDs)), hard disk drives (HDDs), magnetic or optical disc drives, or other suitable computer medium that electronically stores information. Moreover, although certain devices or components of the vehicle electronics 20 may be described as including a processor and/or memory, the processor and/or memory of such devices or components may be shared with other devices or components and/or housed in (or a part of) other devices or components of the vehicle electronics 20—for example, any of these processors or memory can be a dedicated processor or memory used only for module or can be shared with other vehicle systems, modules, devices, components, etc.

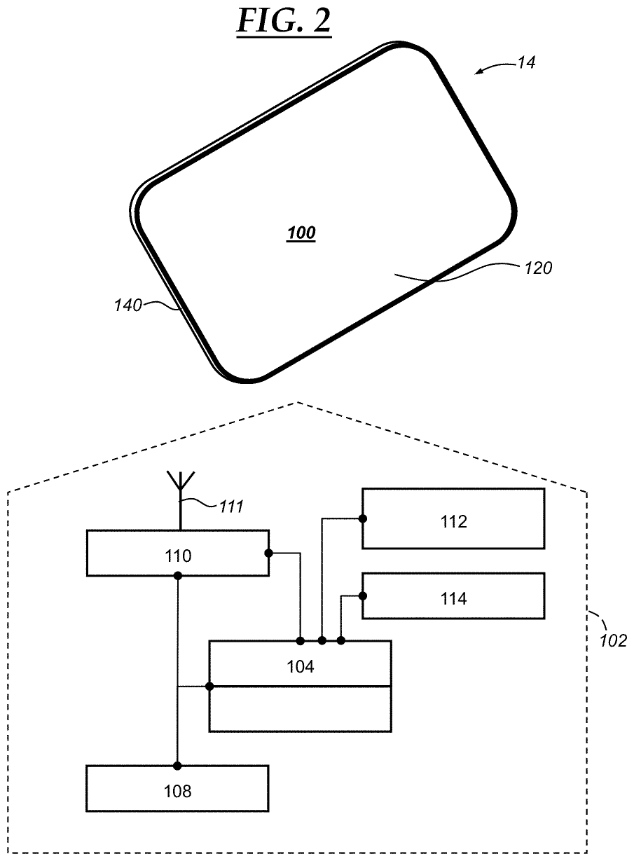

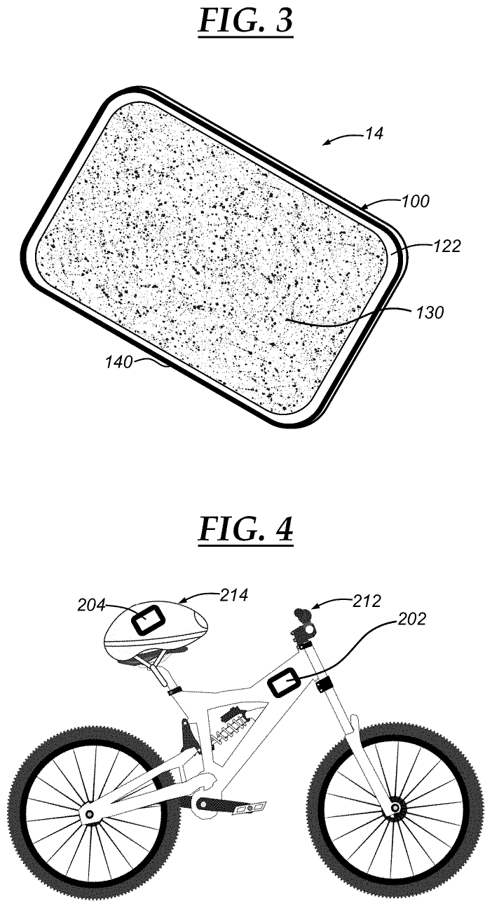

With reference to FIGS. 2-3, there is shown the sensor tag 14 having housing 100 and sensor tag electronics 102. The illustrated sensor tag 14 has a first surface 120 (or front surface in the illustrated embodiment) that is shaped as a rectangle with rounded corners, and a second surface 122 (or back surface in the illustrated embodiment) that is shaped as a complementary rectangle with rounded corners and is the same shape as the first surface 120. The sides 140 of the sensor tag 14 extend between the first surface 120 and the second surface 122 at a periphery of these surfaces. Although an exemplary shape of the sensor tag 14 is illustrated in FIGS. 2-3, it should be appreciated that many other shapes and structures can be used for the sensor tag 14. The sensor tag 14 can be constructed to be various different sizes. For example, the surfaces 120 and 122 of the sensor tag 14 of FIGS. 2-3 can be one to size inches in length. In another embodiment, the front surface 120 and the back surface 122 can be circular with a diameter of one to six inches, for example. Of course, these are merely exemplary shapes and sizes as many other shapes and sizes can be used.

The sensor tag 14 can be used to track a personal item or asset of a user. Some examples of assets that may be tracked using the sensor tag 14 are a bicycle, a briefcase, vehicle keys, a gym bag, luggage, a child car seat, a pet (e.g., a dog, a cat), etc. The sensor may be protected by an environmentally sealed casing, such as housing 100, which is attachable to an asset. The sensor tag thus enables the asset, which (in many scenarios) does not include means of being detectable or trackable by the vehicle, to be detected and tracked by the vehicle. The sensor tag 14 includes attachment means that fix the sensor tag 14 to an asset. As shown in FIG. 3, the attachment means can include an adhesive 130 that is applied to the back surface 122 (or other surface) of the sensor tag 14. In another embodiment, the attachment means can include one or more clips, suction cups or suckers, hooks, hook-and-loop fasteners (e.g., Velcro™), magnets, snap fasteners (e.g. press stud, popper), pins, a lanyard, a hole in the housing of the sensor tag, or any other suitable attachment mechanism.

The sensor tag electronics 102 are shown in FIG. 2 and include a processor 104, memory 106, battery 108, short-range wireless communication (SRWC) circuit 110, RFID component 112, and inertial sensor 114. The processor 104 can be any type of device capable of processing electronic instructions including microprocessors, microcontrollers, host processors, controllers, vehicle communication processors, General Processing Unit (GPU), accelerators, Field Programmable Gated Arrays (FPGA), and Application Specific Integrated Circuits (ASICs), to cite a few possibilities. The processor 104 can execute various types of electronic instructions, such as software and/or firmware programs stored in memory 106, which enable the module to carry out various functionality. The memory 106 can be a non-transitory computer-readable medium and/or other suitable memory, including, for example, different types of random-access memory (RAM) (including various types of dynamic RAM (DRAM) and static RAM (SRAM)), read-only memory (ROM), solid-state drives (SSDs) (including other solid-state storage such as solid state hybrid drives (SSHDs)), hard disk drives (HDDs), magnetic or optical disc drives, or other suitable computer medium that electronically stores information. In one embodiment, the sensor tag electronics 102 can include a removable memory device, such as a flash drive or universal serial bus (USB) dongle that includes the memory 106. Or, in another embodiment, the removable memory device can be used or provided in addition to the memory 106. The processor 104 can determine the state of one or more devices or components of the sensor tag electronics 102, and this information or data concerning these state(s) is referred to as sensor tag state information. This sensor tag state information can include sensor tag sensor data, which is sensor data from one or more sensor tag components, such as the inertial sensor 114.

The sensor tag 14 also includes a battery 108 that is used to power the sensor tag electronics 102. In one embodiment, the battery 108 is a lithium-ion battery that can be replaced by a consumer or user of the sensor tag 14. For example, the sensor tag 14 can include a battery access portion (not shown) that includes a detachable or removable portion that can be held in place magnetically or mechanically, such as by a latch or a screw. Of course other means of attachment can be used as well. In other embodiments, the battery 108 is rechargeable and, in such embodiments, the sensor tag 14 can include a charging port and/or may be capable of inductive (or wireless) charging. In the case that sensor tag 14 includes a charging port, the battery 108 can be coupled to a power source, such as a vehicle battery included in vehicle 12 or to an outlet of a building or structure, via a power supply. The power supply can include a transformer and/or an AC-to-DC converter so that, for example, a power source having 120V AC can be converted to 5V DC. The charging port can provide a universal serial bus (USB) type connection or any other suitable interface or connection means that are known to those skilled in the art. In some embodiments, a power supply may not be needed such as when the charging port of the sensor tag 14 is a USB port to which a USB cable may be plugged into. In such an example, the other connector of the USB cable can be connected to another device, such as vehicle 12 or a laptop. The cable can be used for charging the sensor tag 14 and/or may be used for data transmissions.

In one embodiment, the sensor tag 14 can include solar charger that uses ambient light (e.g., sunlight) for charging the battery 108. In such embodiments, the solar or photovoltaic cells (referred to collectively as “solar cells”) can be disposed along the front surface 120 of the sensor tag 14 so that when the sensor tag 14 is attached or fixed to an asset, the solar cells are still exposed to the environment.

The SRWC circuit 110 enables the sensor tag 14 to communicate with one or more SRWC devices (e.g., the wireless communications device 30, the HWD 90) via SRWC techniques, which can include Wi-Fi™, WiMAX™, Wi-Fi Direct™, other IEEE 802.11 protocols, ZigBee™, Bluetooth™, Bluetooth™ Low Energy (BLE), or near field communication (NFC). The SRWC circuit 110 can transmit and receive communications via antenna 111 and, although a single antenna 111 for the SRWC circuit 110 is depicted in FIG. 2, it should be appreciated that a plurality of antennas can be used for communications between the SRWC circuit 110 and another SRWC device. In one embodiment, the SRWC circuit 110 can implement Bluetooth™ 5.1 technology for purposes of SRWC, and for purposes of determining a relative location and/or orientation (both examples of a “relative position”) between the sensor tag 14 and another SRWC device, such as the wireless communication device 30 of the vehicle 12. For example, through use of Bluetooth 5.1, the angle of arrival (AoA) and/or the angle of departure (AoD) can be determined, which can be used to determine the direction of the sensor tag 14 relative to the vehicle 12. According to some embodiments, this direction-finding technique can be applied to determine the azimuth and elevation of a first SRWC device (e.g., the sensor tag 14) relative to a second SRWC device (e.g., the wireless communications device 30 of the vehicle 12). Also, in some embodiments, a distance or range between SRWC devices can be determined as well using the SRWC circuit 110. For example, the Received Signal Strength Indicator (RSSI) or other signal strength indicator can be used to determine the distance between the sensor tag 14 and the wireless communications device 30.

The sensor tag 14 can include a radio frequency identification (RFID) circuit and antenna, which is collectively referred to herein as an RFID component 112. In such an example, information contained within the RFID component 112 can be read by an RFID reader. The RFID reader(s) 48 of the vehicle 12 can be capable of reading or obtaining information from the RFID component 112 of the sensor tag 14. In one embodiment, the RFID component 112 includes a dynamic RFID tag (or includes circuitry of a dynamic RFID tag) such that the sensor tag electronics 102 can modify data contained as a part of the RFID circuit. In one embodiment, this dynamic RFID circuit can be used to convey sensor tag sensor data (or other sensor tag state information) to the vehicle or other device having an RFID reader. In some embodiments, the RFID component 112 can be provided in lieu of the SRWC circuit 110. And, according to at least some embodiments, the RFID can include a sensor tag identifier, which is discussed more below.

The inertial sensor 114 is a sensor tag component and can be used to obtain sensor tag inertial sensor data, which is a type of sensor tag sensor data that may be used to determine the acceleration and the direction of the acceleration of the sensor tag or a part thereof. Although only one inertial sensor 114 is discussed and shown in the illustrated embodiment, it should be appreciated that the sensor tag 14 can include a plurality of inertial sensors. Any of these inertial sensors can be microelectromechanical systems (MEMS) sensor or accelerometer, and may be part of an inertia measurement unit (IMU). In one embodiment, the inertial sensor can be used to detect the orientation of the sensor tag relative to earth (or the direction of gravity). In one embodiment, sensor tag inertial sensor data can be continuously gathered and sent to the processor 104 (or other portions of the sensor tag electronics 102), which may then process the sensor tag inertial sensor data for various purposes. In some embodiments, any one or more of the inertial sensor(s) can be a multi-axis accelerometer that can measure acceleration or inertial force along a plurality of axes. Other embodiments may employ single-axis accelerometers or a combination of single- and multi-axis accelerometers. Other types of sensors can be used, including other accelerometers, gyroscope sensors, and/or other inertial sensors that are known or that may become known in the art.

According to some embodiments, the sensor tag can further include one or more other sensors, including a digital thermometer, a touch sensor, a haptic sensor, a photodetector, a camera, other light sensors, a microphone, a digital compass, a humidity sensor, a rain sensor or gauge, and various other sensors. The sensor tag can include any one or more of these sensors, and which can be provided in lieu of or in addition to the inertial sensor 114, at least according to some embodiments. Moreover, according to some embodiments, the sensor tag 14 can include various human-machine interfaces (HMIs), including input HMIs and output HMIs. An input HMI is an HMI that is capable of receiving input from a user, and an output HMI is an HMI that is capable of providing output to a user. Some examples of input HMIs that can be incorporated into the sensor tag 14 (according to some embodiments) are as follows: a microphone, a pushbutton, a switch, a potentiometer, and a touch sensor (e.g., a capacitive touch sensor, a resistive touch sensor, including those that are incorporated into a touchscreen display). Some examples of output HMIs that can be incorporated into the sensor tag 14 (according to some embodiments) are as follows: a light emitting diode (LED), another light emitting device, a speaker, a haptic device (e.g., vibrator), and a display. Any one or more of these input HMIs and output HMIs can be incorporated into the sensor tag 14. For example, the sensor tag 14 can have a speaker as well as three LEDs that are disposed along the front surface 120.

According to one embodiment, the sensor tag 14 can include a visual identifier (referred to herein as a “sensor tag visual identifier”) that is provided on the front surface 120 (or other surface). The sensor tag visual identifier is a static image, graphic, code, or other information that is printed on a substrate, such as a sticker or the surface 120 (or other surface) of the sensor tag 14. The sensor tag visual identifier can be a general sensor tag visual identifier that can be used to identify the sensor tag as a sensor tag (as opposed to another object), and/or can be a unique sensor tag visual identifier that can be used to identify the sensor tag uniquely with respect to other sensor tags. An example of a general sensor tag visual identifier would be a colored portion of the surface 120 that is a particular shape and color, such as a hot pink vehicle icon or OEM logo. An example of a unique sensor tag visual identifier would be a QR code, another two-dimensional barcode, other barcodes, a unique graphic, etc. The sensor tag 14 can be manufactured to include the visual identifier on a surface of the sensor tag 14, or the visual identifier may be provided separately along with the sensor tag, such as on a sticker that can be placed by a user onto a surface of the sensor tag 14.

With reference to FIG. 4, there is shown a scenario in which a first sensor tag 202 is attached to a first asset (a bicycle in this example) 212, and in which a second sensor tag 204 is attached to a second asset (a helmet in this example) 214. The discussion herein concerning the sensor tag 14 applies equally to the first sensor tag 202 and the second sensor tag 204, as well as numerous other potential assets or items that could be used instead.

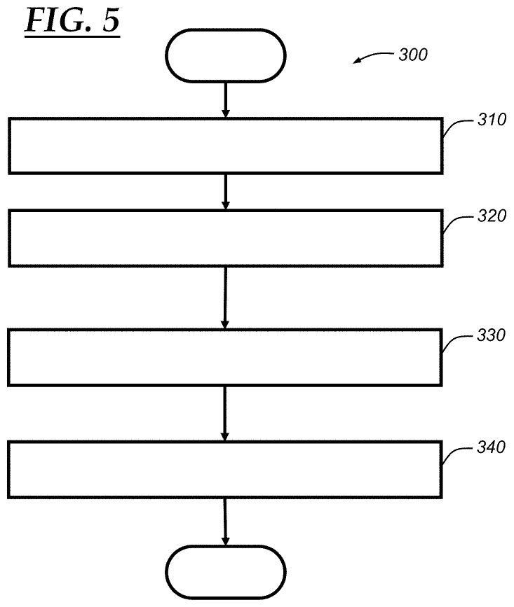

With reference to FIG. 5, there is shown a flowchart depicting an embodiment of a sensor tag configuration process 300. Any one or more of the steps of the sensor tag configuration process 300 can be used as a part of a method of carrying out a vehicle action based on a state of a sensor tag that is attachable to an asset. The process 300 can be carried out by the vehicle electronics 20, the remote facility 80, the HWD 90, the sensor tag electronics 102, or a combination thereof. In one embodiment, the onboard computer 22 and/or other portions of the vehicle electronics 20 can carry out all or most of the process 300. Also, in embodiments where the vehicle electronics 20 carries out one or more steps, the vehicle electronics 20 can do so using existing vehicle hardware (at least in some embodiments). Although the process 300 is described below as being carried out in a particular order, it is hereby contemplated that the process 300 can be carried out in any technically-feasible order as appreciated by those skilled in the art.

The process 300 begins with step 310, wherein a sensor tag association request is received. The sensor tag association request is a request or instruction to associate a sensor tag with a vehicle. According to some embodiments, the sensor tag association request is a manual request, which is a request that is initiated by a user, such as through use of a graphical user interface (GUI) of a computer application being executed on a user device (e.g., HWD 90, vehicle 12, a personal computer). For example, the user can initiate the sensor tag configuration application 92 on the HWD 90, which can then include a button or other selectable component that is used to add a new sensor tag (e.g., a graphical button with a label stating “ADD SENSOR TAG”). In another embodiment, the user can operate the vehicle-user interfaces to provide the sensor tag association request, such as through navigating a GUI presented on the visual display 50. In yet another embodiment, the sensor tag 14 can include near field communication (NFC) capabilities and the vehicle 12 can include an NFC reader. The user can physically place the sensor tag 14 near (including touching the sensor tag 14 to) the NFC reader of the vehicle 12, which can then recognize the presence of the sensor tag 14 and/or obtain information from the sensor tag, such as a sensor tag identifier as discussed more below.

According to some embodiments, the sensor tag association request in step 310 is an automatic request, which is a request that is automatically generated by the vehicle and/or the sensor tag. In one embodiment, the vehicle 12 can detect the presence of the sensor tag 14 via detecting a wireless signal being transmitted by the sensor tag 14. For example, the sensor tag 14 can periodically transmit a wireless signal (using SRWC circuit 110) indicating its presence, which can then be received by the wireless communications device 30 of the vehicle 12 when the wireless communications device 30 is near or within range of the SRWC circuit 110. In such embodiments, the sensor tag 14 can send a sensor tag identifier to the vehicle 12, and this sensor tag identifier can be a part of the initial wireless signal that is transmitted periodically, or may be sent as a part of a subsequent wireless signal. In other embodiments, the vehicle 12 can periodically transmit or broadcast a message that indicates the vehicle is ready and/or capable of pairing or being associated with one or more sensor tags. In such embodiments, the sensor tag 14 can thus receive this wireless signal and then respond by sending a response wireless signal, which can include the sensor tag identifier (at least in some embodiments). In another embodiment, the sensor tag 14 can carry out these communications with the HWD 90 instead of the vehicle 12. For example, when the user selects “ADD SENSOR TAG”, the HWD 90 can transmit a wireless message using a SRWC circuit (e.g., a BLE message), which can then be received by the sensor tag 14. The sensor tag 14 can then send a response message that includes its sensor tag identifier. In yet another embodiment, the sensor tag 14 can transmit a wireless signal in response to a user operating an input HMI of the sensor tag when the sensor tag is near (or within range of) the vehicle.

In another embodiment, the vehicle can detect the sensor tag 14 at the vehicle 12 through the one or more RFID readers 48, can determine that the sensor tag is new to the vehicle (i.e., no association between the sensor tag and the vehicle currently exists), and then can automatically associate the sensor tag with the vehicle or may prompt a user for whether they desire to associate the sensor tag with the vehicle. The user can then indicate their desire via one or more input HMIs of the vehicle 12 or the sensor tag 14.

In one embodiment where the sensor tag includes a sensor tag visual identifier, the user can hold and/or position the sensor tag 14 in the field of view of a camera such that the sensor tag visual identifier can be detected by the camera. For example, the sensor tag 14 can be held by the user in this manner in the field of view of the vehicle camera 46 and, in another example, the sensor tag 14 can be held by the user in this manner in the field of view of a camera provided on the HWD 90. In one such embodiment, the sensor tag visual identifier can be a unique sensor tag visual identifier, such as a QR code. The vehicle 12 can obtain image data containing this QR code and can then determine the information contained within the QR code, which can be a sensor tag identifier. A particular sensor tag can be identified based on a sensor tag identifier, which can be (for example) a unique string of alphanumeric characters, such as a universally unique identifier (UUID). The sensor tag identifier is used to distinguish a particular sensor tag from other sensor tags. In some embodiments, the sensor tag identifier can be electronically stored in memory 106 of the sensor tag 14, represented by the RFID component 112 of the sensor tag 14, included as a part of the sensor tag visual identifier (e.g., encoded in a QR code), and/or may be stored in databases 88 of the remote facility 80. Also, as will be discussed more below, when the sensor tag is associated with a particular vehicle such as the vehicle 12, the sensor tag identifier can be stored in memory of that vehicle, such as in memory 26 of the onboard computer 22. The process 300 then continues to step 320.

In step 320, the sensor tag is associated with a vehicle. This step of associating the sensor tag with the vehicle can include: obtaining a sensor tag identifier; obtaining a vehicle identifier; and storing information in memory that associates the sensor tag identifier (or the sensor tag) with the vehicle identifier (or the vehicle). In some embodiments, this associating step can be carried out by the vehicle 12, the remote facility 80, the HWD 90, and/or the sensor tag 14. In an embodiment when the user is operating the sensor tag configuration application 92 on the HWD 90, the sensor tag identifier can be entered into a GUI of the HWD 90 by the user (e.g., by using an on-screen keyboard) or may be detected by holding up the sensor tag visual identifier in front of a camera of the HWD 90. In another embodiment, the sensor tag 14 can wirelessly send the sensor tag identifier to the HWD 90 via SRWCs (e.g., BLE, NFC in the case the HWD 90 has a NFC reader). The HWD 90 can also receive the vehicle identifier in a like-manner, such as through the user entering the vehicle identifier (e.g., VIN) into the GUI of the HWD 90, or through wireless communications (e.g., BLE) between the HWD 90 and the wireless communications device 30. Once the HWD 90 receives the sensor tag identifier and the vehicle identifier, the HWD 90 can store the sensor tag identifier and the vehicle identifier and/or send these identifiers to the remote facility 80. In other embodiments, the HWD 90 can obtain the sensor tag identifier from the user or the sensor tag 14, and then send the sensor tag identifier to the vehicle using SRWCs, for example.

In another embodiment, the sensor tag identifier can be obtained by the vehicle 12. As mentioned above, in one embodiment, the sensor tag identifier can be obtained from the HWD 90. In other embodiments, the sensor tag identifier can be obtained from the sensor tag electronics 102, such as from the SRWC circuit 110 and/or the RFID component 112. For example, in some embodiments, the sensor tag identifier can be obtained through wireless communications between the wireless communications device 30 of the vehicle 12 and the SRWC circuit 110 of the sensor tag 14, such as through those communications discussed above with respect to step 310. In one embodiment, the sensor tag 14 and the wireless communications device 30 can establish a secured SRWC connection that can be used to securely send information using SRWC, including the sensor tag identifier. This secured SRWC connection can be a Bluetooth connection, such as a Bluetooth 5.1 connection. Once the vehicle 12 obtains the sensor tag identifier, the vehicle can store the sensor tag identifier into memory of the vehicle, such as in memory 26, memory of the memory of the wireless communications device 30, and/or memory of the BCM 38. In some embodiments, the vehicle 12 can also obtain the vehicle identifier from memory of the vehicle 12, and send the vehicle identifier and the sensor tag identifier to the remote facility 80, which can then store information into databases 88 that associates the sensor tag (or the sensor tag identifier) with the vehicle (or the vehicle identifier). In some embodiments, the vehicle does not need to send the vehicle identifier to the remote facility 80 at this time as the remote facility 80 may determine the identity of the vehicle (and, thus, the vehicle identifier) based on information pertaining to a remote connection between the vehicle and the remote facility 80. Thus, according to various embodiments, the vehicle identifier of the vehicle that sends the sensor tag identifier can be identified at the remote facility 80. The process 300 continues to step 330.

In step 330, asset attribute information is received. The asset attribute information is information describing or indicating the characteristics of an asset to which the sensor tag 14 is attached (or is intended to be attached). The asset attribute information can include an asset type, asset environment parameters, asset transport parameters, asset residence, asset physical attributes, and an asset owner (or user). The asset attribute information can be inputted by a user into the HWD 90, the vehicle 12, or another computer application, such as a web application that is accessible via a personal computer (PC). In one embodiment, the GUI can include input fields for various types of information. These input fields can include predetermined and selectable values for the various types of asset attribute information. For example, the GUI can include an input field for the asset type, which can provide a list of selectable asset types. The asset types can specify a category that the asset falls within, such as “Luggage,” “Bicycle,” “Fragile Item,” “Food,” and “Pet”. The asset environment parameters specify certain environmental conditions suitable (or not suitable) for the asset, such as a minimum and/or maximum temperature, an indicator indicating whether water may damage the asset, an ingress protection rating or level including dust/solid particle protection and/or water protection (e.g., IP45, IPX6), a minimum and/or maximum humidity, susceptibility to ultraviolet radiation or other effects due to exposure to sunlight, etc. The asset transport parameters specify certain information regarding the transportation of the asset using the vehicle, such as whether the asset will be (or is intended on being) transported within the vehicle or on the outside of the vehicle, a location within the vehicle (e.g., in the trunk, on a vehicle seat) or on the vehicle (e.g., on a roof rack, on a rear portion of the vehicle, attached to a hitch of the vehicle) of the asset when the asset is being transported, an orientation of the asset (including a desired orientation of the asset) when the asset is being transported, the brittleness or fragility of the asset (e.g., the resiliency of the asset when the vehicle is travelling over a bumpy road, such as a dirt road or a road with potholes), etc.

The asset residence specifies a location for which the asset typically is stored or that the asset typically occupies. The asset residence can be a geographical location, such as the home of the user or the workplace of the user. In some embodiments, the asset residence can also be relative to another asset, such as the vehicle—that is, for example, the asset residence can be specified as being the vehicle, or can be specified as the asset residence of another asset. As an example, and with reference to FIG. 4, the first sensor tag 202 is attached to the bicycle 212 that has an asset residence of the home of the user, and a second sensor tag 204 is attached to the helmet 214 that has an asset residence that is the asset residence of the bicycle, which in this example is the home of the user. Thus, when the asset residence of the bicycle 212 is modified (e.g., by a user at a later time) to be the workplace of the user, the asset residence of the helmet 214 is automatically set to be the workplace of the user as well or as a result of this modification. The asset physical attributes specify physical properties of the asset, such as the size, shape, and appearance of the asset. The user can input the size and/or shape of the asset into the GUI of the HWD 90, the vehicle 12, personal computer, or other device. The asset owner (or user) can specify a certain individual that is considered the owner of (or that is otherwise associated with) the asset. This information can be used in conjunction with sensor state information, vehicle state information (e.g., the identity of users present at the vehicle), and/or other information pertaining to other electronic devices (e.g., the HWD 90) to determine whether to carry out a particular vehicle action.

Although the asset attribute information is described as being manually inputted by the user, in other embodiments, the asset attribute information can be automatically obtained from a database (e.g., databases 88, another database of another remote facility) based on an asset product identifier, such as a product number (e.g., model number, universal product code (UPC)) or other identifying information. For example, databases 88 or a database that is accessible via the Internet can be accessed using the asset product identifier to retrieve asset attribute information for the identified product. In one embodiment, the asset product identifier can be entered into the GUI by the user. Additionally or alternatively, the asset product identifier can be obtained by using the camera of the HWD 90 or the vehicle camera 46 to obtain image data containing the asset. Then, through use of image processing techniques (which can be executed locally at the HWD 90 or vehicle 12, or remotely at a remote server), the product can be identified and information pertaining to identified product (e.g., asset attribute information) can be obtained by the HWD 90 or the vehicle 12, which can include accessing this information from an application programming interface (API) via the Internet or a remote connection using land network 76 and/or wireless carrier system 70. Once the asset attribute information is obtained, either automatically or through manual input by the user, the asset attribute information can be sent to the remote facility 80, and can be stored in databases 88 and/or stored in memory of the vehicle (e.g., memory 26 of the onboard computer 22, memory of the wireless communications device 30, memory of the BCM 38). The asset attribute information can be stored in memory with the sensor tag identifier so that the asset attribute information is associated with the sensor tag. In addition to entering the asset attribute information, the user can provide a name for the asset (referred to herein as the “asset name”), such as “Helmet” or “John's Bike.” These names can be used by the vehicle 12, the HWD 90, or another device to refer to the asset in a user-friendly manner. The process 300 continues to step 340.

In step 340, after the asset attribute information is received, the asset attribute information is stored in memory. The asset attribute information can be stored locally at the device that received the asset attribute information, and/or remotely at the remote facility 80, such as in databases 88. In embodiments where the asset attribute information is received at the vehicle 12, the asset attribute information can be stored in memory 26 of the onboard computer 22, or another memory of the vehicle. In embodiments where the asset attribute information is received at the HWD 90, the asset attribute information can be sent to the vehicle via a SRWC connection between the HWD 90 and the vehicle 12, or via a remote connection (e.g., using wireless carrier system 70 and/or land network 76) between the HWD 90 and the vehicle 12. In embodiments where the asset attribute information is received at the personal computer or another device, the asset attribute information can be sent to the vehicle 12 via a remote connection or other suitable connection (e.g., SRWC). Once the vehicle 12 receives the asset attribute information, the vehicle 12 can store the asset attribute information into memory. In some embodiments, such as where the sensor tag 14 includes suitable memory resources, the asset attribute information may even be stored at the sensor tag 14. This could potentially simplify the configuration process in the event that the asset was ever associated with a different vehicle, as all of the requisite information would already be maintained at the sensor tag. The process 300 then ends.

In one embodiment, the process 300 can further include a calibration step in which the orientation of the sensor tag 14, with respect to the asset to which it is attached can be determined. As mentioned above, the sensor tag 14 can include various types of attachment means, such as an adhesive surface. The user may attach or fix the sensor tag 14 to an asset but the sensor tag may be angled relative to the asset—that is, the user may attach the sensor tag 14 to the asset in a variety of manners with each having a different relative orientation between the asset and the sensor tag 14. Thus, in such a case, the orientation of the sensor tag may be different than the orientation of the asset. A calibration step can be carried out to determine the relative orientation between the sensor tag 14 and the asset. In one embodiment, the calibration step includes providing an instruction to the user (via an output HMI) to place, hold, or otherwise position the asset upright and, after a predetermined amount of time or once the user confirms the asset is positioned upright, then the sensor tag 14 can take a measurement of the sensor tag's orientation with respect to gravity (or earth) through use of inertial sensor 114. This measurement can thus be used as the difference between the orientation of the sensor tag 14 and the asset (or the “relative orientation” of the asset and the sensor tag). In some embodiments, this step can further include calibrating the orientation with respect to multiple axes through use of a multi-axis accelerometer or other inertial sensor installed as a part of the sensor tag electronics 102.

In some scenarios, the user may decide to change the asset to which the sensor tag 14 is attached to, or to otherwise modify the asset attribute information or other information pertaining to the sensor tag. In such scenarios, for example, the user can use the vehicle electronics 20, the HWD 90, a personal computer, or another device to change the asset attribute information. In some embodiments, the process 300 can further include receiving a request to update, edit, or change the asset attribute information or other information pertaining to the sensor tag 14. This request can be received at the vehicle 12 via one or more vehicle-user interfaces 50-56 (e.g., the visual display 50), at the HWD 90 via one or more HMIs of the HWD 90, or at another device such as the personal computer. In response, for example when the request is received at the vehicle 12, the visual display 50 of the vehicle electronics 20 can present an asset attribute modification screen of a graphical user interface (GUI) (such as the GUI used above in the process 300) that enables the user to modify the asset attribute information, the asset name, or other information concerning the asset or the sensor tag. In embodiments where the request is received at the HWD 90 (or another device), the HWD 90 (or the other device) can present the asset attribute modification screen using a GUI. The user can then use HMI (e.g., vehicle-user interfaces 50-56) to provide the changes to the asset attribute information and, once these changes are received, the changes (or the updated asset attribute information) can be stored in memory, such as that which is described in step 340 of the process 300.

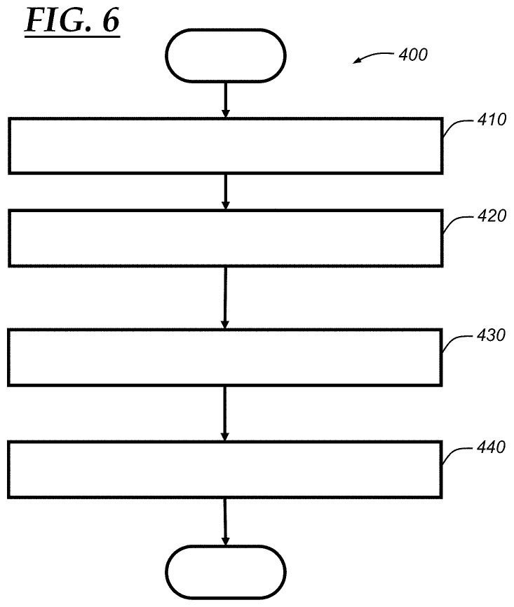

With reference to FIG. 6, there is shown a vehicle trigger event detection process 400, which may be part of a method of carrying out a vehicle action in response to detecting a vehicle trigger event. A vehicle trigger event is based on the occurrence of a vehicle trigger, and a vehicle trigger is based on one or more vehicle conditions. Each of the vehicle conditions is a predetermined condition that pertains to the vehicle state and/or the sensor tag state. For example, with reference to FIG. 4, an exemplary vehicle condition can be the presence or absence of the first sensor tag 202, or the presence or absence of the second sensor tag 204. An example of a vehicle trigger can include the following conditions: first sensor tag 202 is present and second sensor tag 204 is absent. Thus, when the vehicle electronics 20 detects the first sensor tag 202 but not the second sensor tag 204, such as through using the RFID readers 48 and/or the wireless communications device 30, it can be said that a vehicle trigger event is detected since the vehicle conditions of the vehicle trigger are satisfied.

The process 400 begins with step 410, wherein a vehicle trigger-action is obtained or established, wherein the vehicle trigger-action specifies a vehicle action to carry out in response to detecting a vehicle trigger event (i.e., the occurrence of a vehicle trigger). The vehicle trigger can include a user-defined vehicle condition or trigger, or an automatically generated condition or trigger. The user-defined vehicle trigger can be specified by input received via input human-machine interface(s) (HMI(s)), such as the vehicle-user interfaces 50-54 of the vehicle 12, or input HMI(s) of the HWD 90. The GUI of the vehicle 12 or the HWD 90 can provide a predetermined list of selectable operators and conditions. For example, in embodiments where the visual display 50 is a touchscreen display, the user can use the display 50 to specify certain conditions of the vehicle trigger, such as by selecting one or more conditions from a predetermined list of conditions and a predetermined list of operators; in this way, the user may define a rather simple vehicle trigger or may build a more complex vehicle trigger having multiple conditions. In some embodiments, the user can select a plurality of conditions for a vehicle trigger, and the vehicle trigger can be configured such that these conditions are either disjunction or conjunction with respect to one another. For example, the user can select a first condition A and a second condition B, and then the user can select a binary operator for these two conditions, such as an “AND” or an “OR” operator. Additionally or alternatively, the user can select a unary operator for any one or more of the conditions of the vehicle trigger, such as a “NOT” operator. Also, according to at least some embodiments, the conditions or conditional expressions (e.g., “A AND NOT B”) can be nested (e.g., “(A AND NOT B) OR C”). When no binary operator is specified, a default operator can be used, such as an “AND” for example. Also, the user can specify the vehicle action to be carried out in response to detecting a vehicle trigger event of the vehicle trigger. The vehicle action can be selected from a predetermined list of vehicle actions.

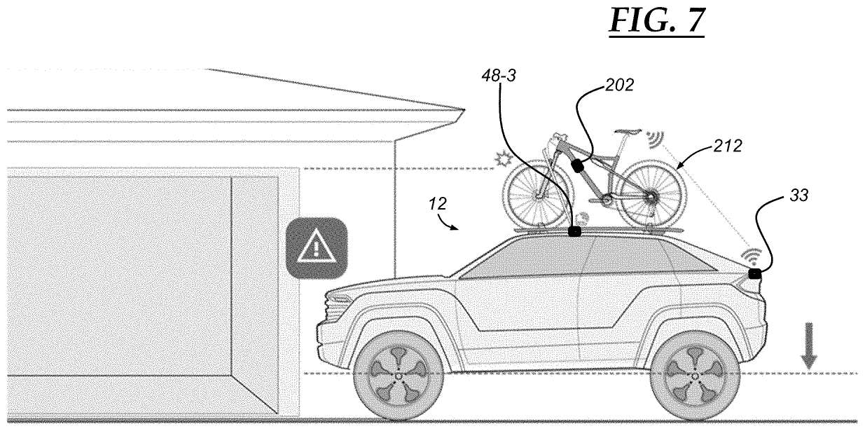

As mentioned above, the vehicle trigger can also be an automatically generated vehicle trigger so that the vehicle condition(s) (or conditional expression) are automatically generated. In at least some embodiments, the vehicle triggers can be automatically generated based on the asset attribute information, and/or based on observed vehicle state information and/or observed sensor tag state information. For example, with reference to FIG. 7, there is shown an exemplary scenario in which the bicycle 212 having the sensor tag 202 is mounted to the roof rack of the vehicle 12. The vehicle 12 has the RFID reader 48-3 mounted near the roof rack of the vehicle 12, such as within the roof of the vehicle 12. The vehicle 12 can determine the presence of the bicycle 212 based on detecting the presence of the sensor tag 202 via the RFID reader 48-3. An example of an automatically generated vehicle trigger can include the conditions (or conditional expression): WHEN asset (or sensor tag) detected on roof, AND (asset height+vehicle height)>clearance height. This vehicle trigger can be a part of a vehicle trigger-action in which, when a vehicle trigger event of the vehicle trigger is detected, then a vehicle action is carried out in response. In the exemplary scenario of FIG. 7, the vehicle action can be to provide an audible and/or visual warning to the vehicle operator, or to decelerate and/or stop the vehicle using autonomous/semi-autonomous functionality. This exemplary vehicle trigger-action can be automatically generated based on the asset attribute information (e.g., the height of the bicycle (or the asset height)). Moreover, in some embodiments, the remote facility 80 or vehicle can include one or more predefined vehicle trigger-actions (e.g., WHEN asset (or sensor tag) detected on roof, AND (asset height+vehicle height)>clearance height, then warn user), and certain portions of this conditional statement can be based on asset attribute information, which, in this example, is the asset height. The process 400 continues to step 420.

In step 420, the vehicle is configured to monitor for a vehicle trigger event (i.e., the occurrence of a vehicle trigger). The vehicle can be configured to monitor for a vehicle trigger event by storing the vehicle trigger into memory. The vehicle action or response of the vehicle trigger-action can also be stored into memory. The vehicle trigger and/or the vehicle action (or the vehicle trigger-action) can be stored into memory 26 of the onboard computer 22, memory of the wireless communications device 30, memory of the BCM 38, and/or other memory of the vehicle electronics 20. In one embodiment, information pertaining to the vehicle trigger can be sent to one or more modules or components of the vehicle electronics 20, such as the BCM 38. In response to receiving this information, for example, the BCM 38 can monitor for one or more conditions of the vehicle trigger, and can report an occurrences of these conditions to the onboard computer 22 (or other modules or components of the vehicle electronics 20). The process 400 then continues to step 430.

In step 430, the method detects a vehicle trigger event. The vehicle trigger event can be detected based on determining that all of the conditions (or the conditional expression) of the vehicle trigger are satisfied. This determination can be made at the onboard computer 22, or may be made at other modules or components of the vehicle electronics 20. In one embodiment, the BCM 38 and/or other modules or components of the vehicle electronics 20 can report certain information to the onboard computer 22, such as vehicle sensor data from the RFID readers 48, from suspension sensors 42, movement sensors 44, and/or camera 46, for example. Also, in some embodiments, such as those where the sensor tag includes the SRWC circuit, the vehicle can receive sensor tag sensor data from the sensor tag. In another example where assets can tip over or spill, asset attribute information associated with the sensor tag 14 can indicate that the asset (e.g., such as a cake or a container with a liquid) must be oriented in a certain manner (e.g., positioned upright) when located inside the vehicle, and the vehicle can be configured to monitor for a vehicle trigger-action that notifies the user via an output HMI (e.g., audio system 56) when the orientation of the asset changes more than a predetermined amount relative to earth (or gravity) and/or relative to the vehicle. The orientation can be determined based on sensor tag sensor data from the inertial sensor 112 and reported to the vehicle via the SRWC circuit 110 (e.g., WHEN orientation of sensor tag>predetermined amount THEN send sensor tag sensor data to vehicle via SRWC). Once a vehicle trigger even is detected, the process 400 continues to step 440.

In step 440, the vehicle action of the vehicle trigger-action is carried out in response to detecting the vehicle trigger event. In at least one embodiment, the onboard computer 22 (or the other device that detected the vehicle trigger event) can send a command to one or more modules or components of the vehicle electronics 20 so as to cause the vehicle action to be carried out. For example, with reference to the exemplary scenario of FIG. 7, the onboard computer 22 can send a command to the audio system 56 in response to detecting a vehicle trigger event of the exemplary vehicle trigger discussed above. The audio system 56 can then provide an audible warning to the driver or other user of the vehicle 12. In another embodiment, the vehicle can carry out one or more autonomous vehicle actions. As used herein, an autonomous vehicle action includes autonomous and semi-autonomous vehicle actions or precautions that are automatically carried out by the vehicle and that affect the vehicle operation, including vehicle propulsion, vehicle braking, vehicle steering, and/or other suitable driving actions. An exemplary vehicle action can be applying the brakes and/or adjusting the steering angle so as to stop or prevent the vehicle from travelling into the garage (since the bicycle 212 would hit the heading of the garage opening). In another example, a vehicle action includes lowering the suspension height of the vehicle by sending a command signal to suspension height electromechanical device 58 assuming this would avoid the bicycle 22 hitting the garage. The process 400 then ends.

In some embodiments, the vehicle trigger-action(s) can be automatically generated and/or modified based on a vehicle trigger-action learning process. The vehicle trigger-action learning process can include monitoring various conditions and states of the vehicle and/or the sensor tag, and determining one or more vehicle actions that improve the user experience based on these monitored conditions and states. The vehicle state information and/or the sensor tag state information can be monitored and recorded, and then machine learning (ML) and/or other artificial intelligence (AI) technique(s) can be applied to this information so as to generate or obtain a vehicle trigger-action. As an example, consider a scenario where a user loads heavy equipment into a trunk of the vehicle. The vehicle can determine that heavy equipment is loaded into the vehicle based on a detected suspension height (as detected using the suspension sensors 42) and/or the asset attribute information associated with the sensor tag. The presence of the heavy equipment can be identified as the user approaches the vehicle based on the detected presence of the sensor tag as it comes within range of detection by the vehicle and, in response, the vehicle can adjust the suspension height so as to lower the rear of the vehicle so that the user does not have to lift the heavy equipment as far to load the heavy equipment into the vehicle.

In at least some embodiments, the vehicle trigger-action learning process can be carried out at the remote facility 80. The databases 88 can store various vehicle state information and/or sensor tag state information that is observed or recorded at a plurality of vehicles. The databases 88 can also store asset attribute information and the associated sensor tags, and can carry out various ML and/or other AI techniques using this asset attribute information, vehicle state information, and/or sensor tag state information. Also, other information obtained from various sources (e.g., from other remote facilities) can be used as a part of the vehicle trigger-action learning process. This other information can be weather information and traffic information, for example. The vehicle trigger-action learning process can generate one or more vehicle trigger-actions, and then transmit these learned vehicle trigger-actions to one or more vehicles so that the vehicle can be configured to monitor for vehicle trigger events of these vehicle trigger-actions, and to carry out the vehicle action in response thereto.

Also, in some embodiments, certain vehicle trigger-actions can be suggested to a user based on the asset attribute information. For example, when a vehicle having a roof rack is associated with a sensor tag, and the sensor tag is associated with asset attribute information indicating that the asset is a bicycle (e.g., the asset type is “Bicycle”), then the vehicle trigger-action of [WHEN asset (or sensor tag) detected on roof, AND (asset height+vehicle height)>clearance height, THEN warn user] can be suggested to the user. Or, in other embodiments, the vehicle can be automatically configured to implement one or more vehicle-trigger actions based on the asset attribute information.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A method of carrying out a vehicle action based on a state of a sensor tag that is attachable to an asset, the method comprising the steps of:
configuring the sensor tag to be associated with the asset, wherein the configuring step includes receiving asset attribute information concerning the asset;
obtaining sensor tag state information regarding a state of the sensor tag, wherein the sensor tag state information includes information received from the sensor tag and/or information concerning the presence or absence of the sensor tag at the vehicle;
detecting a vehicle trigger event, wherein the vehicle trigger event is based on an occurrence of a vehicle trigger, and the vehicle trigger specifies one or more conditions pertaining to the state of the sensor tag; and
carrying out a vehicle action at the vehicle in response to the detection of the vehicle trigger event, wherein the vehicle action is part of a vehicle trigger-action and is designed to address the one or more conditions of the vehicle trigger event.

2. The method of claim 1, wherein the configuring step includes receiving the asset attribute information at the vehicle, and storing the asset attribute information at the vehicle.

3. The method of claim 2, wherein the asset attribute information is received via a vehicle-user interface, and the asset attribute information is manually input into a graphical user interface by a user through the vehicle-user interface.

4. The method of claim 2, wherein the asset attribute information is received from one or more servers at a remote facility or from a handheld wireless device (HWD).

5. The method of claim 1, wherein the sensor tag includes a radio frequency identifier (RFID) component, the vehicle includes one or more RFID readers, and the sensor tag state information is obtained by detecting the presence or absence of the sensor tag at the vehicle via the one or more RFID readers detecting the RFID component.

6. The method of claim 1, wherein the sensor tag includes a short-range wireless communication (SRWC) circuit, the sensor tag state information is obtained by receiving a wireless SRWC signal at the vehicle from the sensor tag via a SRWC connection between the sensor tag and the vehicle.

7. The method of claim 6, wherein the position of the sensor tag is determined relative to the vehicle or a reference component of the vehicle based on an angle of arrival (AoA) and/or an angle of departure (AoD) of the wireless signal.

8. The method of claim 6, wherein the sensor tag includes an inertial sensor, and the sensor tag state information includes information based on a measurement of the inertial sensor.

9. The method of claim 7, wherein the configuring step includes obtaining orientation information concerning an orientation of the sensor tag relative to the asset so that an orientation of the asset relative to earth or gravity can be determined based on the measurement of the inertial sensor.

10. The method of claim 1, wherein the vehicle trigger is a user-defined vehicle trigger that is specified by input received from a user input via one or more human-machine interfaces.

11. The method of claim 1, wherein the vehicle trigger is an automatically generated vehicle trigger that is generated based on the asset attribute information, and the vehicle trigger is automatically generated at a remote facility or is automatically generated at the vehicle based on information received from the remote facility.

12. The method of claim 11, wherein the vehicle trigger is automatically generated through a vehicle trigger-action learning process, wherein the vehicle trigger-action learning process includes processing previously observed vehicle state information and previously observed sensor tag state information using an artificial intelligence (AI) technique.

13. The method of claim 1, wherein the sensor tag includes a housing, and wherein an adhesive is applied to at least one surface of the housing of the sensor tag so as to enable the sensor tag to be adhered to the asset.

14. A vehicle communication system, comprising:
at least one sensor tag that is attachable to an asset and that includes sensor tag electronics, the sensor tag electronics include a radio frequency identifier (RFID) component and/or a short-range wireless communication (SRWC) circuit;
vehicle electronics for installation in a vehicle, the vehicle electronics include:
one or more RFID readers and/or one or more SRWC circuits;
an onboard computer having a processor;
a memory storing computer instructions, the memory is accessible by the processor of the onboard computer;
wherein, when the processor of the onboard computer executes the computer instructions, the vehicle electronics:
obtain sensor tag state information regarding a state of the sensor tag, wherein the sensor tag state information includes information received from the sensor tag and/or information concerning the presence or absence of the sensor tag at the vehicle;
detect a vehicle trigger event, wherein the vehicle trigger event is based on an occurrence of a vehicle trigger, and the vehicle trigger specifies one or more conditions pertaining to the state of the sensor tag; and
carry out a vehicle action at the vehicle in response to the detection of the vehicle trigger event, wherein the vehicle action is part of a vehicle trigger-action and is designed to address the one or more conditions of the vehicle trigger event.

15. The vehicle communication system of claim 14, wherein the at least one sensor tag includes the RFID component and lacks the SRWC circuit or any SRWC circuit, and wherein the vehicle electronics includes a plurality of RFID readers positioned around the vehicle so as to have separate RFID read zones.

16. The vehicle communication system of 15, wherein the at least one sensor tag each includes attachment mechanism for being attached to the asset.

17. The vehicle communication system of claim 16, wherein the attachment mechanism includes an adhesive disposed on an outer surface of a housing of the sensor tag.

18. The vehicle communication system of claim 14, wherein the at least one sensor tag includes a plurality of sensor tags, and wherein the one or more conditions of the vehicle trigger pertain to at least two of the plurality of sensor tags.

19. The vehicle communication system of claim 14, wherein the sensor tag includes at least one sensor, wherein the sensor tag includes the SRWC circuit, and wherein the sensor tag is configured to send the sensor tag state information to the vehicle via the SRWC circuit.

20. A method of carrying out a vehicle action based on a state of a sensor tag, the method comprising the steps of:
associating a sensor tag with a vehicle, wherein the associating step includes storing a sensor tag identifier and a vehicle identifier in a manner such that the sensor tag identifier is linked or associated with the vehicle identifier;
receiving asset attribute information at the vehicle, wherein the asset attribute information is information concerning an asset to which the sensor tag is attached or is to be attached;
configuring the vehicle to monitor for a vehicle trigger event, wherein the vehicle trigger event is based on an occurrence of a vehicle trigger, the vehicle trigger specifies one or more conditions pertaining to the state of the sensor tag, and the configuring step includes storing information representing the one or more conditions of the vehicle trigger into memory of the vehicle;
obtaining sensor tag state information regarding a state of the sensor tag, wherein the sensor tag state information includes information received from the sensor tag and/or information concerning the presence or absence of the sensor tag at the vehicle;
monitoring for a vehicle trigger event based on the obtained sensor tag state information and the stored information representing the one or more conditions of the vehicle trigger;
detecting the vehicle trigger event at the vehicle; and
carrying out a vehicle action at the vehicle in response to the detection of the vehicle trigger event, wherein the vehicle action is part of a vehicle trigger-action and is designed to address the one or more conditions of the vehicle trigger event.
